(19) United States
(12) Patent Application Publication
(10) Pub. No.: US 2026/0094246 A1
(43) Pub. Date: Apr. 2, 2026

(54) CONTROLLABLE UNIVERSAL EDGE-PRESERVING IMAGE FILTERING

(71) Applicant: DOLBY LABORATORIES LICENSING CORPORATION

(72) Inventors: Shijun Liang, East Lansing, MI (US); Dongdong Fu, Cupertino, CA (US)

(73) Assignee: DOLBY LABORATORIES LICENSING CORPORATION, (US)

(21) Appl. No.: 19/340,692

(22) Filed: Sep. 25, 2025

Related U.S. Application Data
(60) Provisional application No. 63/700,181, filed on Sep. 27, 2024.
(60) Provisional application No. 63/719,608, filed on Nov. 12, 2024.

(51) Int. Cl. G06T 5/60; G06T 5/20; G06T 5/70; G06T 5/77

(52) U.S. Cl. CPC G06T 5/60; G06T 5/20; G06T 5/70; G06T 5/77; G06T 2207/20016; G06T 2207/20028; G06T 2207/20081; G06T 2207/20084; G06T 2207/20192

(57) ABSTRACT

Systems and methods for controllable image processing. One example provides a communication interface configured to receive an input image and an image processing setting; and an adaptive neural network configured to iteratively update, using a loss function with adjustable parameters based on the image processing setting, using a loss function with adjustable parameters based on the image processing setting, updatable parameters of the adaptive neural network based on the input image, and generate an output image based on the updated parameters, wherein the output image has image processing effects corresponding to the image processing setting.

### CROSS-REFERENCE TO RELATED APPLICATIONS

This application claims priority to U.S. provisional application No. 63/700,181, filed on Sep. 27, 2024, and U.S. provisional application No. 63/719,608, filed on Nov. 12, 2024, all of which are incorporated herein by reference in their entirety.

### TECHNICAL FIELD

The present application relates to image processing and, more specifically, to neural network-based methods for controllable image enhancement including image smoothing, denoising, and inpainting.

### BACKGROUND

Unless otherwise indicated herein, the materials described in this section are not prior art to the claims in this application and are not admitted as prior art by inclusion in this section.

Image processing refers to the manipulation or modification of digital images using algorithms and techniques. Image processing includes operations such as enhancement, restoration, and compression. Image smoothing is an example of the image processing operation that aims to reduce noise or fine-scale details in an image while preserving larger-scale structures.

Edge-preserving refers to a characteristic of some image processing techniques, including the smoothing operations, where the algorithm maintains sharp transitions (edges) between different regions of an image while still applying the desired effect to other areas. In image processing tasks, the degree of smoothing may affect how well the target image processing effects can be achieved. For different images, the degree of smoothing for reaching the target image processing effects may be different.

Kernel-based methods for processing local image content are employed to preserve edges using spatial and intensity cues. Deep learning-based models including end-to-end trained Convolutional Neural Networks (CNNs) are employed in denoising and image reconstruction to capture edge and enhance smoothness.

### SUMMARY

Deep Image Prior (DIP) techniques, as well as other deep learning-based methods, enhance image smoothing but may experience shortfalls in flexibility and controllability. While other known methods are more adaptable and provide further controllability, many exhibit subpar performance. For example, some end-to-end deep learning models offer control over edge preservation yet remain suboptimal in performance.

Embodiments of the present disclosure overcome such shortcomings by providing a system for controllable image processing, improving the functioning of image processing devices by providing user control while achieving versatile, high-quality image processing outcomes. For example, some embodiments of the present disclosure provide a network architecture that diverges from U-Net models, using a Laplacian pyramid as the encoder and a deep decoder as the decoder, integrated with a bilateral filter loss to improve DIP. Use of the Laplacian pyramid, the deep decoder, and/or the bilateral filter aids the network in rapidly assimilating essential low-frequency information. Examples described herein provide advantages in retaining texture details and improving image smoothing and related tasks beyond the capabilities of standard DIP methods. Moreover, examples described herein outperform the leading unsupervised method, Laplacian pyramid texture filtering, in texture filtering tasks and other applications.

According to embodiments of the present disclosure, a system for controllable image processing comprises a communication interface configured to receive an input image and an image processing setting; and an adaptive neural network configured to iteratively update, using a loss function with adjustable parameters based on the image processing setting, updatable parameters of the adaptive neural network based on the input image, and generate an output image based on the updated parameters, wherein the output image has image processing effects corresponding to the image processing setting.

According to embodiments of the present disclosure, a computer-implemented method for controllable image processing comprises receiving an input image and an image processing setting; iteratively updating, using a loss function with adjustable parameters based on the image processing setting, updatable parameters of the adaptive neural network based on the input image; and generate an output image using the adaptive neural network with the updated parameters, wherein the output image has image processing effects corresponding to the image processing setting.

According to embodiments of the present disclosure, an apparatus for controllable image processing comprises an electronic processor; and a memory storing computer executable instructions, wherein the computer executable instructions, when executed, cause the electronic processor to receive an input image and an image processing setting; iteratively update, using a loss function with adjustable parameters based on the image processing setting, using a loss function with adjustable parameters based on the image processing setting, updatable parameters of the adaptive neural network based on the input image; and generate an output image using the adaptive neural network with the updated parameters, wherein the output image has image processing effects corresponding to the image processing setting.

### DESCRIPTION OF THE DRAWINGS

FIG. 1 illustrates an example of an image processing system according to aspects of the present disclosure.

FIG. 2 shows an example of an image editing process according to aspects of the present disclosure.

FIG. 3 shows an example of neural network architecture according to aspects of the present disclosure.

FIG. 4 shows an example of the image processing apparatus according to aspects of the present disclosure.

FIG. 5 shows an example of a single-shot image processing application according to aspects of the present disclosure.

FIG. 6 shows an example of the frequency band mask according to aspects of the present disclosure.

FIG. 7 shows an example of an image processing method according to aspects of the present disclosure.

FIG. 8 shows an example of an image processing method according to aspects of the present disclosure.

### DETAILED DESCRIPTION

This disclosure and aspects thereof can be embodied in various forms, including hardware, devices or circuits controlled by computer-implemented methods, computer program products, computer systems and networks, user interfaces, and application programming interfaces; as well as hardware-implemented methods, signal processing circuits, memory arrays, application specific integrated circuits (ASICs), field programmable gate arrays (FPGAs), and the like. The foregoing is intended solely to give a general idea of various aspects of the present disclosure, and does not limit the scope of the disclosure in any way.

Image processing involves using techniques to enhance, modify, or restore images. Some image processing techniques struggle with complex tasks such as edge-preserving smoothing, noise reduction in high-detail areas, or context-aware inpainting. These challenges are acute when dealing with diverse image types or fine-grained control over the processing effects are needed.

For example, edge-preserving smoothing (EPS) is used in image processing for tasks like denoising and HDR tone mapping, as it removes minor details while retaining the main structure. However, differentiating between texture and structure poses challenges due to similar visual elements. Advances in EPS have led to methods including kernel-based local, optimization-based global, and deep learning-based techniques.

Kernel-based local methods include the bilateral filter, which preserves edges using spatial and intensity cues, and the guided image filter, which provides efficiency and the ability to avoid gradient reversal. The local Laplacian filter is another method in this category, employing a multi-scale approach for nuanced feature preservation. However, these methods may struggle with complex image structures, and differentiating between texture and structure poses challenges due to similar visual elements.

Optimization-based global methods include techniques like Relative Total Variation (RTV) for emphasizing larger structures, Weighted Least Square (WLS) filter for preserving salient edges and suppressing various artifacts, and the L0 smoothing technique which minimizes the L0 norm to preserve significant edges selectively.

Deep learning models, including end-to-end trained CNNs models include neural network models trained on large datasets to perform image processing tasks. While these methods can produce impressive results, they may require extensive training and labeled data, with limitations in post-editing adaptability.

Recent developments have introduced approaches such as DeepFSPIS, which utilizes a UNet-in-UNet architecture in conjunction with a careful design loss function for unpaired data smoothing. Additionally, some parameterized image operators have been introduced, employing a decoupled learning algorithm that facilitates dynamic weight adjustment during image processing operations. While these methods have enhanced the controllability of deep networks, there remain challenges in consistently achieving optimal performance across various scenarios.

Deep Image Prior (DIP) is an unsupervised deep learning technique that adapts to each specific image. Some DIP-based methods utilize the architecture of a CNN to provide a robust solution for image reconstruction from a Gaussian noise in the absence of training data. However, it can be unpredictable and hard to control, as these methods may be easy to overfit and lacks controllability. For example, Lipschitz constant of the network layers may be incorporated to reduce overfitting and to control the spectral bias. However, the DIP in this example is still easy to overfit and lacks controllability.

Pyramid Texture Filtering technique uses a multi-scale approach to process images at different levels of detail. Some methods utilizing this technique, like texture filtering and joint edge detection networks, have enhanced smoothing efficiency. Some methods such as innovative energy functions that capture edge and enhance smoothness and deep weighted least squares filters, wherein networks are trained using a weighted least squares loss, have demonstrated to be effective. However, these methods may struggle with consistently achieving optimal performance across various scenarios.

Examples of the present disclosure address these technical challenges by providing an adaptive neural network architecture that combines the flexibility of deep learning with controllability. The present disclosure improves the functioning of image processing techniques, systems, and devices by providing user control for these techniques, systems, and devices while achieving versatile, high-quality image processing outcomes. This improvement is achieved by using the adaptive neural network architecture. The adaptive neural network architecture incorporates a loss function with adjustable parameters that are adjusted based on target image processing effects. The adaptive neural network architecture also includes updatable parameters that can be updated based on the input image during a single-shot image processing task.

Aspects of the present disclosure provide an adaptive neural network architecture that iteratively updates adjustable parameters of a loss function based on user-defined image processing settings. In some aspects, examples of the present disclosure involves incorporating a loss function including a bilateral filter loss with adjustable spatial and range kernel parameters, enabling precise control over edge preservation and smoothing effects. The adaptive neural network architecture integrates Laplacian pyramid filtering while complying with pixel adaptive convolution. In some aspects, examples of the present disclosure involves employing a multi-scale processing approach using parallel feature pyramids for both the input image and a noise-based guidance image, allowing for effective handling of features at various scales. In some aspects, examples of the present disclosure involves applying Pixel-Adaptive Convolution with Trainable (PAC^{T}) kernels to enable context-aware local image processing.

In the disclosure, an “adaptive” neural network refers to a neural network that dynamically adjusts parameters for an input image based on an image processing setting. For example, the adaptive neural network may initiate a set of adjustable parameters based a user-provided image processing setting. The adaptive neural network may further perform iterative adjustments to update updatable parameters based on the input image. Accordingly, the adaptive neural network adjusts parameters in real-time for an individual image processing task.

“Single-shot” image processing refers to an approach where the desired image processing effect is achieved in a single, integrated operation from the user's perspective, without multiple separate processing steps. the single-shot image processing does not require pre-training on large datasets or fine-tuning for specific tasks. The adaptive neural network may adapt itself for each input image based on the provided processing settings. For example, while the internal workings of the neural network may involve multiple iterations to refine the output, the entire process from initialization to final result may be encapsulated in a single operation.

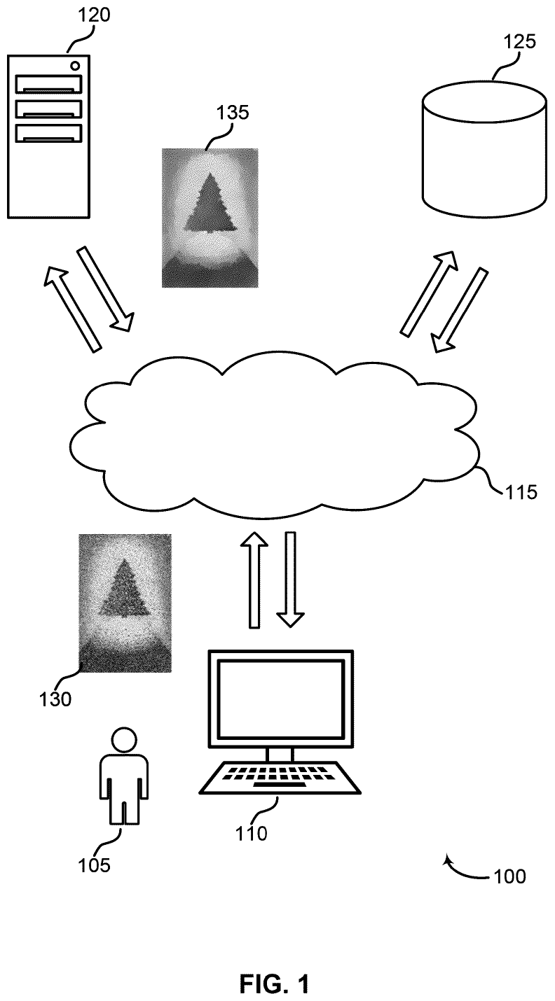

FIG. 1 illustrates an example of an image processing system 100 according to aspects of the present disclosure. The image processing system 100 includes user device 110, cloud 115, image processing apparatus 120, and database 125. In the example illustrated in FIG. 1, user 105 provides an input image 130. The image processing system 100 process the input image 130 based on a controllable image processing setting, generating output image 135.

In the example illustrated in FIG. 1, the user 105 interacts with image processing system 100 via a user device 110. The user device 110 may be a personal computer, laptop computer, mobile device, tablet, or any other suitable processing apparatus capable of running an image processing application. The user device 110 includes a user interface that enables the user 105 to input images, specify image processing settings, and view processed images. The user device 110 may also include a display screen configured to display images, video, text, and/or data to the user. The display screen may be a liquid crystal display (LCD) screen, an organic light emitting display (OLED) display screen, a waveguide display, a quantum dot display, or the like. The user interface may be integrated with the display screen (e.g., a touch screen device). The user device 110 is connected to a cloud 115. The cloud 115 may provide on-demand availability of computer system resources for image processing. The cloud 115 facilitates communication between the user device 110 and other components of the image processing system 100.

In some examples, the cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some examples, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

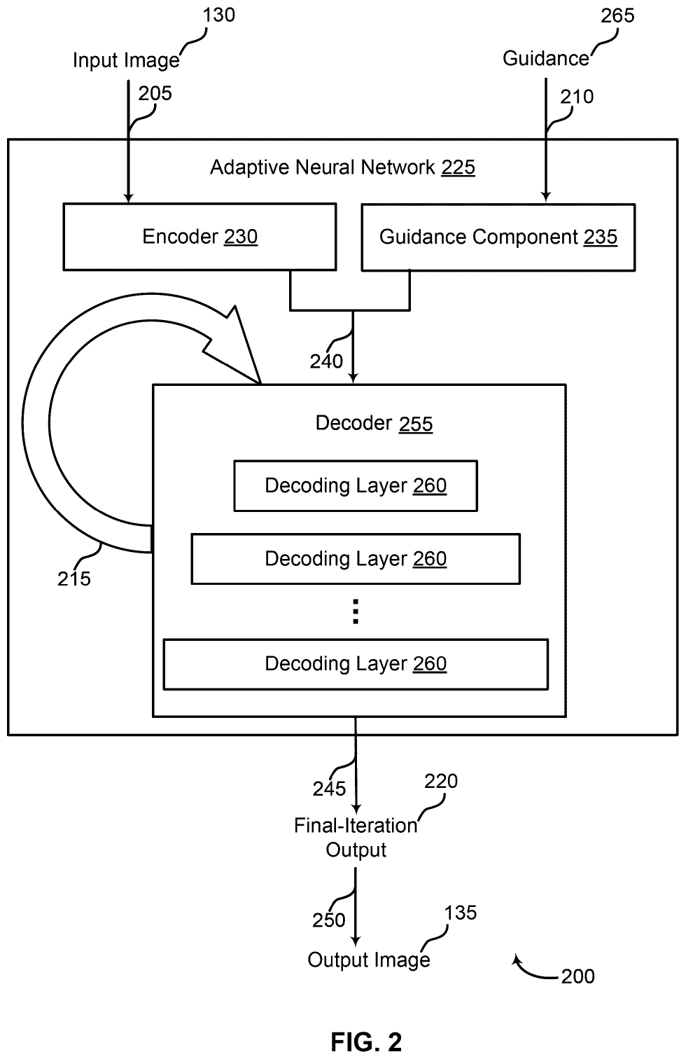

The image processing apparatus 120 may perform image editing tasks. The image processing apparatus 120 includes an adaptive neural network and performs image processing tasks. For example, the image processing apparatus 120 receives the input image 130 and a processing setting from the user device 110 via the cloud 115, processes the images using the adaptive neural network, and returns the output image 135. The adaptive neural network may be adjusted based on the input image 130 and the processing setting. The processing setting may be an example of the guidance 265 (shown in FIG. 2).

For example, the adaptive neural network includes adjustable parameters of the loss function that are determined based on the processing setting. The adaptive network also includes updatable parameters of the adaptive network that are updated during an iterative updating process based on the input image 130. In some examples, final-iteration output 220 (shown in FIG. 2) may be retrieved as the output image 135.

In some examples, the image processing apparatus 120 is implemented on a server. A server provides one or more functions to users linked by way of one or more of the various networks. In some examples, the server includes a single microprocessor board, which includes a microprocessor responsible for controlling all aspects of the server. In some examples, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some examples, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or other suitable processing apparatus.

The image processing system 100 includes a database 125. The database 125 may store data related to image processing, such as models, image processing settings, and processed images. The image processing apparatus 120 can access and store data in the database 125 during image processing tasks. In some examples, the database 125 is an organized collection of data. For example, database 125 stores data in a specified format known as a schema. Database 125 may be structured as a single database, a distributed database, multiple distributed databases, or an emergency backup database. In some examples, a database controller may manage data storage and processing in database 125. In some examples, a user interacts with the database controller. In other cases, database controllers may operate automatically without user interaction.

The input image 130 may be an original image that the user 105 wants to process. The user 105 may provide a guidance. A guidance refers to an input that steers the neural network towards generating images that meet criteria or follow instructions indicated by the guidance. For example, a guidance may be an image processing setting, such as values of adjustable parameters of an image generation neural network. A guidance may also be an instruction indicating target image enhancement effects, such as “smoother and less edge”, where the image processing setting can be obtained based on the instruction. The image processing setting guides the neural network to generate images with image enhancement effects such as image smoothing, image denoising, and image inpainting. However, aspects of the present disclosure are not necessarily limited thereto, and other image enhancement effects may also be included.

The input image 130 is sent from the user device 110 through the cloud 115 to the image processing apparatus 120 for processing. As a result of processing the input image 130, the image processing apparatus 120 generates an output image 135. The output image 135 depicts the results of applying the specified image processing effects to the input image 130. The output image 135 is sent through the cloud 115 to the user device 110 for the user 105 to view, save, or further manipulate.

Examples described herein related to image smoothing and edge preservation. According to some aspects, an image smoothing problem may be formulated as:

$${x}^{*} = arg {min}_{x} {‖ Ax - y ‖}_{2}^{2} + ℛ ( x ) \qquad ( 1 )$$

where A is the measurement operator. For example, when the task is image smoothing, A is the identity operator and y is the original image. The explicit regularizer R(·) is used to restrict the solutions to the space of desirable images. Examples of the regularizer may vary from the l₁ penalty on wavelet coefficients or a total variation penalty to patch-based sparsity in learned dictionaries.

Deep image prior (DIP) may be used for the image editing process 200. DIP may be formulated as:

$$\hat{θ} = {arg min}_{θ} {‖ {f}_{θ} ( z ) - y ‖}_{2}^{2} , \hat{x} = {f}_{\hat{θ}} ( z ) \qquad ( 2 )$$

where f is a CNN with parameters θ and z is a fixed network input that may be randomly chosen (e.g., a random Gaussian vector or tensor). The DIP using the Equation (2) may be referred to as a vanilla DIP.

A low pass filter loss regularization may be included in a loss function to guide the DIP. The low-pass-filter-guided DIP formulation can be formulated as:

$$\hat{θ} = {arg min}_{θ} {‖ {f}_{θ} ( z ) - y ‖}^{2} + {‖ {Hf}_{θ} ( z ) ‖}^{2} \qquad ( 3 )$$

where H is the low pass operator, z is the network with weights w, and y is the input image. The DIP using the Equation (3) may be referred to as a low pass DIP.

A Neural Tangent Kernel (NTK) is an example mathematical tool used to analyze the training dynamics of neural networks, including in the infinite-width setting. NTK provides an approximation of the function space explored by a neural network during gradient-based training, such as gradient descent or stochastic gradient descent. Under the NTK, the evolution of the network can be described by a first-order expansion of Equation (3) around a random Initialization by the Taylor expansion:

$${w}_{t + 1} = {w}_{t} - η {∇}_{w} ℒ ( {w}_{t} ) \qquad ( 4 )$$

where w are the trainable network parameters at a certain training iteration t, η is a step size parameter, and L represents the loss function to be minimized. Rearranging equation 4 then provides:

$$\frac{{w}_{t + 1} - {w}_{t}}{η} = - {∇}_{w} ℒ ( {w}_{t} ) \qquad ( 5 )$$

When η is small, for example, within the range of 0.001 to 0.01, the Equation (5) approximates the differential equation:

$$\frac{dw}{dt} = - {∇}_{w} ℒ ( w ) \qquad ( 6 )$$

In this example, the network input is fixed in the DIP setting. The network output z may thus be formulated as a function of w. Applying the chain rule gives that:

$$\frac{dz ( w )}{dt} = ∇ {z ( w )}^{T} \frac{dw}{dt} \qquad ( 7 )$$

Substituting the loss from equation (3) into equation (6) then provides:

$$\frac{dz ( w )}{dt} = - ∇ z ( w ) ( z ( w ) - y ) - ∇ z ( w ) {H}^{T} ( H z ( w ) ) \qquad ( 8 )$$

Under the NTK, the matrix W: =∇z(w)^{T}∇z(w) (the neural tangent kernel) remains fixed throughout training. In this example, Equation (8) can be rediscretized to show that the training dynamics of low-pass DIP may be reduce to:

$${z}_{t + 1} = {z}_{t} + W ( \overline{y} - {z}_{t} ) - {WH}^{T} H ( {z}_{t} ) \qquad ( 9 )$$

In this example, gradient descent may be started from a random initialization θ₀ with independent and identically distributed entries from a normal distribution with mean 0 and variance ω. Next, a training dynamic of the adaptive neural network may thus be obtained.

When there is no noise for the image x and the low pass filter is symmetric, the MSE of DIP with low pass regularization may be formulated as:

$${MSE}_{t} = {‖ {𝔼}_{n} [ {z}_{t} ] - x ‖}^{2} = {‖ {( I - η W - η {WH}^{T} H )}^{t} x ‖}^{2} \qquad ( 10 )$$

In comparison, the MSE of the original DIP problem is:

$${MSE}_{t} = {‖ {( I - η W )}^{t} x ‖}^{2} \qquad ( 10 )$$

In this example, the DIP with low pass regularization can prioritize low-frequency features by minimizing the impact of high-frequency components, thereby facilitating faster and more efficient learning of essential image information such as shapes and general patterns.

In some aspects, a training scheme for DIP with the incorporation of a bilateral filter loss is provided. An optimization function for managing low-amplitude structures while concurrently preserving and accentuating prominent edges is provided:

$$\hat{θ} = {arg min}_{θ} {\sum }_{i = 1}^{N} {‖ {{f}_{θ} ( z )}_{i} - {u}_{i} ‖}^{2} + λ {\sum }_{j ∈ {N}_{h} ( i )} {w}_{i , j} \cdot {‖ {{f}_{θ} ( z )}_{i} - {{f}_{θ} ( z )}_{j} ‖}^{p} ) \qquad ( 12 )$$

In this example, f_{θ}(z) represents the output image from the network, and |·|p denotes the Lₚ norm. The term Nₕ(i) refers to the adjacent pixels of pixel i within its h×h window, and wi,j represents the weight assigned to the pixel pairs. The weight w_{i,j} is derived as follows:

$$\begin{matrix}{w}_{i , j} = {w}_{i , j}^{r} * {w}_{i , j}^{s} \\ {w}_{i , j}^{r} = exp ( - \frac{{\sum }_{c} {( {u}_{i , c} - {u}_{j , c} )}^{2}}{2 {σ}_{r}^{2}} ) \\ {w}_{i , j}^{s} = exp ( - \frac{{( {x}_{i} - {x}_{j} )}^{2} + {( {y}_{i} - {y}_{j} )}^{2}}{2 {σ}_{s}^{2}} )\end{matrix} \qquad ( 13 )$$

In this example, σᵣ and σₛ denote the standard deviations of Gaussian kernels in the color and spatial domains, respectively. The variable c indicates the image channel, while x and y represent pixel coordinates. By integrating the bilateral loss, the range and spatial kernels of the adaptive neural network 225 can be adjusted, thus providing a controllable image enhancement solution. Furthermore, this training framework alleviates the need for extensive labeling efforts.

FIG. 2 shows an example of an image editing process 200 according to aspects of the present disclosure. The image editing process 200 may be performed for image enhancement tasks including image smoothing, image denoising, and image inpainting.

As illustrated in FIG. 2, the example image editing process 200 includes the input image 130, the guidance 265, the image encoding process 205, the guidance encoding process 210, the adaptive neural network 225, the iterative updating process 215, the final iteration 245, the final-iteration output 220, the output image retrieval process 250, and the output image 135.

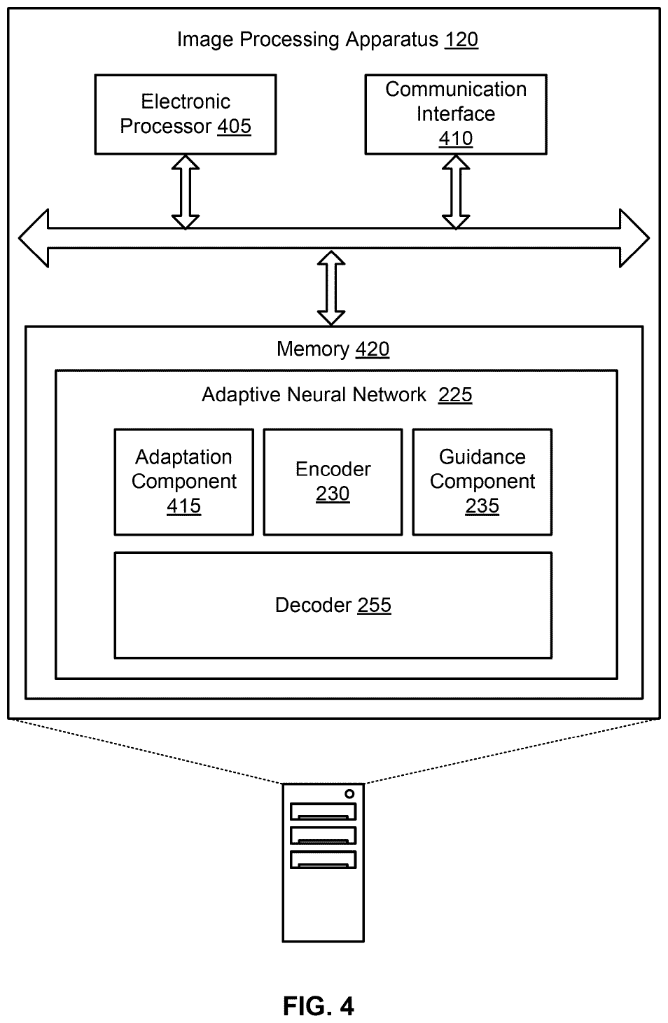

The adaptive neural network 225 includes the encoder 230, the guidance component 235, and the decoder 255, which are further illustrated in FIG. 4. Parameters of the encoder 230 are fixed, and the decoder 255 are trained through the neural network. In the image editing process 200, the input image 130 and the guidance 265 are input into the adaptive neural network 225. In the image encoding process 205, the adaptive neural network 225 generates an image encoding based on the input image 130 using the encoder 230. In the guidance encoding process, the adaptive neural network 225 generates a guidance encoding based on the guidance 265 using the guidance component 235. Next, the adaptive neural network 225 performs the decoding process 240 on the output of the encoder 230 and the guidance component 235 using the decoder 255.

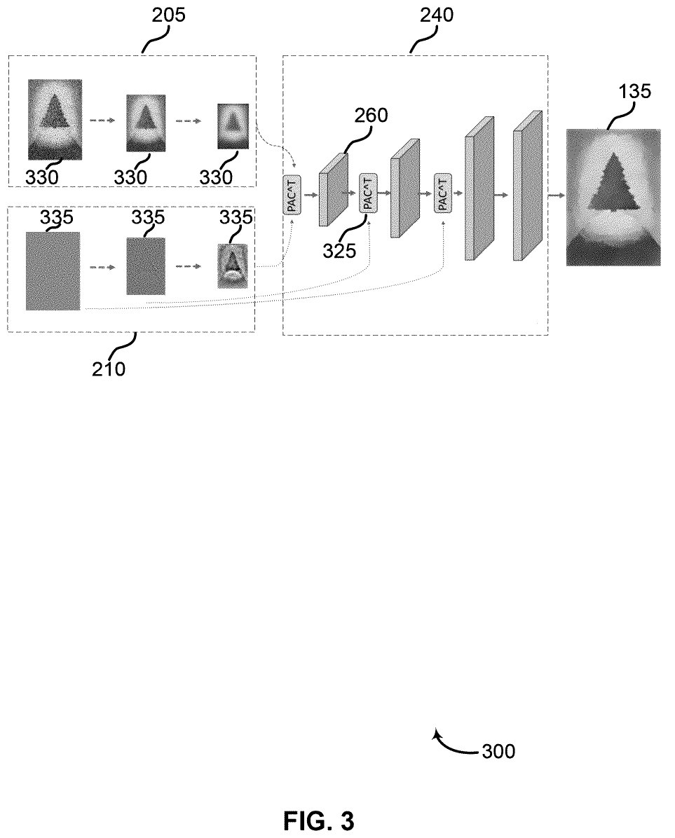

The image editing process 200 also includes image encoding process 205, guidance encoding process 210, decoding process 240, which are further illustrated in FIG. 3. FIG. 3 shows an example of neural network architecture 300 according to aspects of the present disclosure. The example includes image encoding process 205, the guidance encoding process 210, decoding process 240, a sequence of input images 330 with progressively reducing spatial resolutions, a sequence of guidance images 335 with progressively reducing spatial resolutions, and the output image 135. The neural network architecture 300 integrates Laplacian pyramid filtering while complying with pixel-adaptive convolution. Referring to FIG. 3, the image encoding process 205 receives the input image 130 and performs multi-scale processing by progressively reducing the spatial resolution of the input image 130 across multiple layers. This progressive reduction in spatial resolution generates a sequence of input images 330 with progressively reducing spatial resolutions. The sequence of input images 330 forms an image feature pyramid. For example, in the image feature pyramid, each subsequent image in the sequence of input images 330 has a lower spatial resolution than the previous image in the sequence of input images 330.

The guidance encoding process 210 operates in parallel with the image encoding process 205. The guidance encoding process 210 receives a guidance image and performs multi-scale processing by progressively reducing the spatial resolution of the guidance image across multiple layers. The progressive reduction in spatial resolution generates a sequence of guidance images 335 with progressively reducing spatial resolutions. The sequence of guidance images 335 forms a guidance feature pyramid, where each subsequent image in the sequence of guidance images 335 has a lower spatial resolution than the previous image in the sequence of guidance images 335. In some examples, the guidance 265 is based on a noise tensor. The noise-based guidance image may help in adapting the image processing to various image characteristics and enhancing the network's ability to handle different types of image content.

The decoding process 240 receives inputs from both the image encoding process 205 and the guidance encoding process 210. The decoding process 240 may involve performing Pixel-Adaptive Convolution (PAC). PAC modifies a standard convolution on an input by altering the spatially invariant filter with an adapting kernel. In some examples, the adaptive kernel is formed using pre-determined features. In some alternative examples, the adaptive kernel is formed using learned features. In these examples, the adaptive kernel is trainable. Applying PAC on an input may involve performing element-wise multiplication of matrices, followed by a summation.

In some examples, the decoding process 240 applies Pixel-Adaptive Convolution with Trainable (PAC^{T}) kernels 325 to the image feature pyramid represented by the sequence of input images 330 and the guidance feature pyramid represented by the sequence of guidance images 335 to process local image content. The decoding process 240 progressively increases the spatial resolution of the processed features to generate an output image 135.

In some examples, the PAC^{T} kernels 325 may preserve intricate details in regions with fine textures and apply more aggressive smoothing in smooth regions. By using applying the PAC^{T} kernels 325, the decoding process 240 provides a context-aware processing that is beneficial for tasks like edge-preserving smoothing or selective denoising. In these tasks, different regions of an image may require different treatment. In some examples, by using the PAC^{T} kernels 325, the adaptive neural network 225 can effectively balance the preservation of essential image structures with the application of desired processing effects, generating more natural and visually pleasing outcomes across various image processing tasks, without the need to be specifically trained for the various image processing tasks.

As illustrated in FIG. 2, the adaptive neural network 225 may perform the decoding process 240 multiple times, refining the updatable parameters based on the loss function and the desired image processing effects provided by users. The image editing process 200 may employ an iterative updating process 215. The iterative updating process 215 uses a loss function with adjustable parameters based on the image processing setting to iteratively update the parameters of the adaptive neural network 225. The loss function has adjustable parameters that are determined based on the image processing setting and prior to the iterative updating process 215. For example, the adjustable parameters correspond to the image processing settings specified by the user. During the iterative updating process 215, the adjustable parameters are fixed, and the updatable parameters are adjusted so that the output image 135 is similar to the input image 130 while the image processing effects are preserved.

By using the iterative updating process 215, the adaptive neural network 225 generates output images that are close to the input image while maintaining the desired image processing effects based on the image processing setting. Examples of the loss function includes Equation (13). The loss function integrates a bilateral loss, and the range and spatial kernels of the adaptive neural network 225 can be adjusted during the iterative updating process 215.

Next, after multiple iterations, the image editing process 200 retrieves a final-iteration output 220. The final iteration may be determined when the difference between the output image of an iteration and the input image is lower than a threshold. After the final iteration is determined, the final-iteration output 220 may be retrieved as the output image 135. In some examples, the output image 135 may be generated based on the final-iteration output 220. Accordingly, the final-iteration output 220 may represent the processed or enhanced image after the adaptive neural network 225 is updated via the iterative updating process.

FIG. 4 shows an example of the image processing apparatus 120 according to aspects of the present disclosure. The image processing apparatus 120 includes electronic processor 405, communication interface 410, and memory 420. The memory 420 includes the adaptive neural network 225 including adaptation component 415, the encoder 230, the guidance component 235, and the decoder 255.

The electronic processor 405 is configured to execute instructions stored in the memory 420 to perform image processing tasks. The electronic processor 305 controls the overall operation of the image processing apparatus 120, including the execution of the adaptive neural network 225 and the processing of input and output images.

The communication interface 410 is configured to receive an input image and an image processing setting. The communication interface 410 may also be used to retrieve and transmit the output image after processing. The communication interface 410 enables the image processing apparatus 120 to interact with external devices or networks, facilitating the input and output of image data.

The memory 420 stores computer-executable instructions and data necessary for the operation of the image processing apparatus 120. The memory 420 includes the adaptive neural network 225, which is the core component responsible for performing the image processing tasks.

The adaptive neural network 225 includes the adaptation component 415, the encoder 230, the guidance component 235, and the decoder 255. The adaptation component 415 is configured to iteratively update the updatable parameters of the adaptive neural network 225. The loss function has adjustable parameters that are determined based on the image processing setting and prior to the iterative updating process 215. By using the adaptation component 415, the adaptive neural network 225 can adjust updatable parameters after receiving the input image 130 to generate the output image 135. In some examples, the encoder 230 receives the input image 130 and performs multi-scale processing by progressively reducing the spatial resolution of the input image 130 across multiple layers to generate an image feature pyramid. The guidance component 235 processes the guidance 265, performing multi-scale processing by progressively reducing the spatial resolution of the guidance 265 across multiple layers to generate a guidance feature pyramid. The decoder 255 applies Pixel-Adaptive Convolution with Trainable (PAC^{T}) kernels 325 to the image feature pyramid from the encoder 230 and the guidance feature pyramid from the guidance component 235 to process local image content.

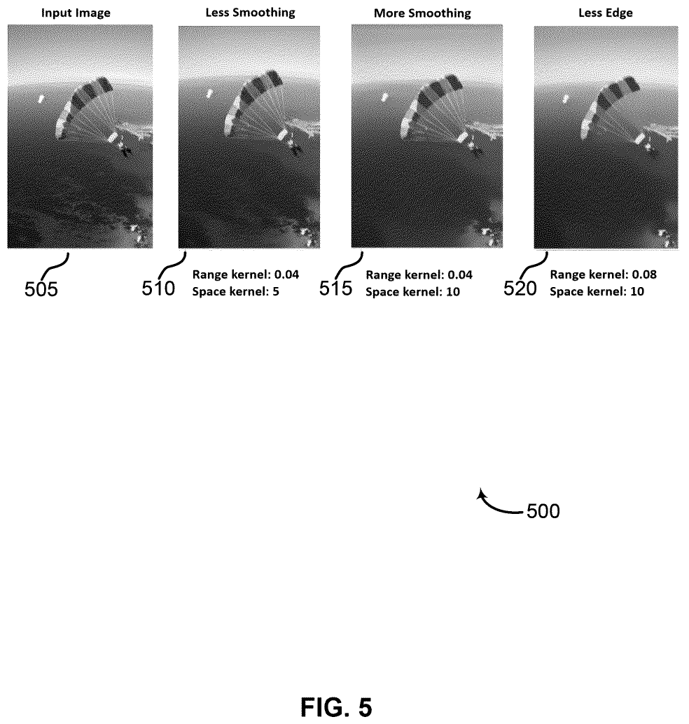

FIG. 5 shows an example of a single-shot image processing application 500 according to aspects of the present disclosure. The example shown includes an experiment input image 505, a first output image 510, second output image 515, and third output image 520.

As illustrated in FIG. 5, given the experiment input image 505, different image processing effects are demonstrated in different output images when different image processing settings are provided. In this example, the image processing settings are controlled by adjusting the range kernel and the space kernel bilateral loss function.

In this example, the first output image 510 is generated by setting the range kernel to be 0.04 and the space kernel to be 5. The second output image 515 is generated by increasing the space kernel to 10 while keeping the range kernel unchanged as 0.04. This setting change causes the second output image 515 to be more smoothing than the first output image 510.

The third output image 520 is generated by increasing the range kernel to 0.08, in contrast to 0.04 for the second output image 515, while keeping the space kernel unchanged as 10. Compared with the second output image 515, the third output image 520 has less edge.

Accordingly, by incorporating a regularized bilateral loss function within the objective function, the variables that govern the spatial and range kernels of the adaptive neural network 225 can be adjusted based on the image processing settings. The adaptive neural network 225 can thus achieve varying degrees of smoothing and edge preservation. This flexibility allows for tailored image processing outcomes, demonstrating the adaptability of our approach to different image characteristics.

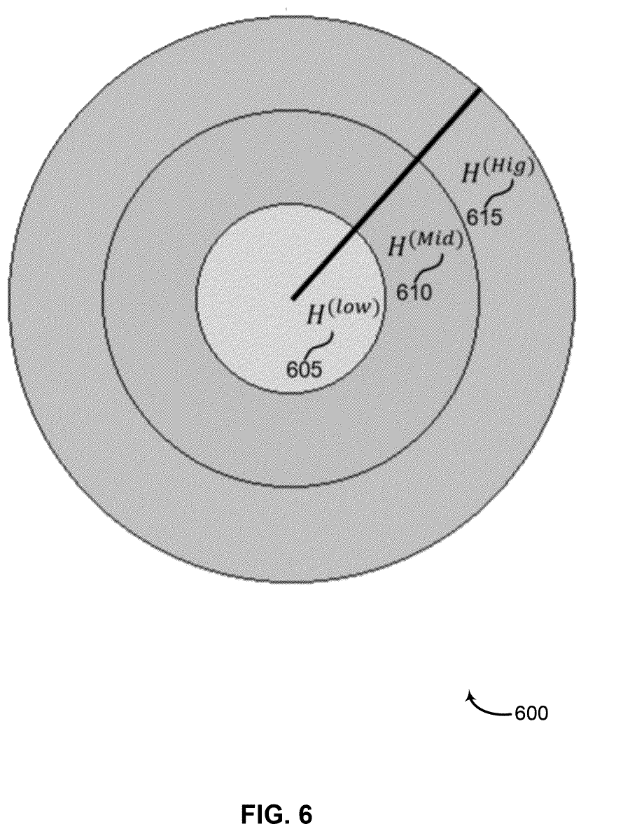

FIG. 6 shows an example of the frequency band mask 600 according to aspects of the present disclosure. According to some examples, the DIP may involve spectral bias, wherein the network exhibits a propensity to learn low-frequency image content more rapidly and accurately compared to high-frequency content. This bias can impede the performance of DIP in tasks such as denoising, as the network may not effectively learn crucial high-frequency content before overfitting occurs.

Examples of the present disclosure includes accelerating the learning of low-frequency content prior to high-frequency content. By incorporating frequency-band metric, the adaptive neural network 225 can more effectively handle image smoothing tasks.

A metric measuring the discrepancies between the frequencies reconstructed and those present in the ground truth is provided:

$$NMSE := \frac{{‖ {M}_{freq} {Ff}_{θ} ( z ) - {M}_{freq} Fy ‖}_{2}^{2}}{{‖ {M}_{freq} Fy ‖}_{2}^{2}} \qquad ( 13 )$$

where M_{freq} is the frequency band mask and F is Fourier transform matrix. The metric of Equation (13) thus measures the consistency between the reconstructed image f_{θ}(z) and the true y in the frequency domain.

The frequency band mask 600 may be segmented into multiple subgroups, each representing a distinct non-overlapping frequency band, based on the symmetrical arrangement around the map's center. In this example, the frequency band mask 600 is segmented into three subgroups: the low-frequency subgroup 605 (H^{low}), the mid-frequency subgroup 610 (H^{mid}), and the high-frequency subgroup 615 (H^{high}).

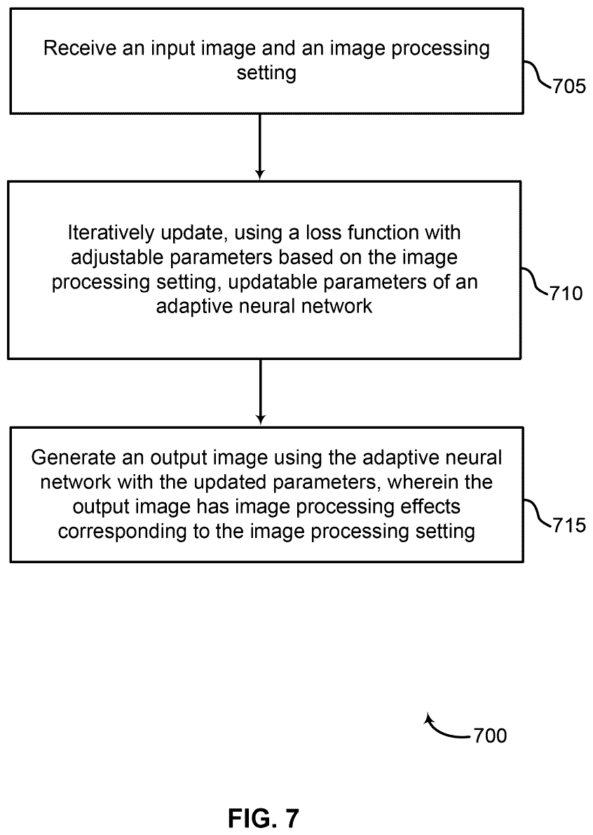

FIG. 7 illustrates a block diagram of a method 700 for adjusting an operating mode of the image processing apparatus 120. The method 700 is described as being executed by the electronic processor 405. However, in some examples, aspects of the method 700 may be performed by another processing device. Additionally, the various process blocks illustrated in FIG. 7 provide examples of various methods disclosed herein, and it is understood that some blocks may be removed, added, combined, or modified without departing from the spirit of the present disclosure.

At operation 705, the image processing system 100 receives an input image 130 and an image processing setting. For example, the operation 705 involves the user 105 interacting with the user device 110 to select an image for processing and specify the desired image processing effects. The user device 110 then transmits this information through the cloud 115 to the image processing apparatus 120.

At operation 710, the image processing system 100 iteratively updates the updatable parameters of the adaptive neural network 225. For example, the adaptive neural network 225 within the image processing apparatus 120 uses a loss function to guide the updating process. The loss function incorporates adjustable parameters that are based on the image processing setting received in operation 705.

In some examples, the loss function used in the iterative updating process includes a bilateral filter loss for edge preservation. The bilateral filter loss may be beneficial for maintaining edge details while still allowing for smoothing or other processing effects. The parameters of this bilateral filter loss include a spatial kernel parameter (σₛ) and a range kernel parameter (σᵣ). These parameters can be adjusted to fine-tune the image processing effects. The spatial kernel parameter (σₛ) controls the influence of spatial distance between pixels, while the range kernel parameter (σᵣ) governs the influence of intensity differences. By adjusting these parameters, the system can achieve a balance between smoothing and edge preservation that's appropriate for the specific image processing task at hand. The spatial kernel parameter (σₛ) and a range kernel parameter (σᵣ) are examples of the adjustable parameters that are based on the image processing setting received in operation 705 and fixed during the iterative updating process.

The iterative updating process involves the network repeatedly adjusting updatable parameters of the network to minimize the loss function. For example, the adjustment process allows the network to learn how to apply the specified image processing effects to the input image. The number of iterations may vary depending on the complexity of the image and the desired processing effects.

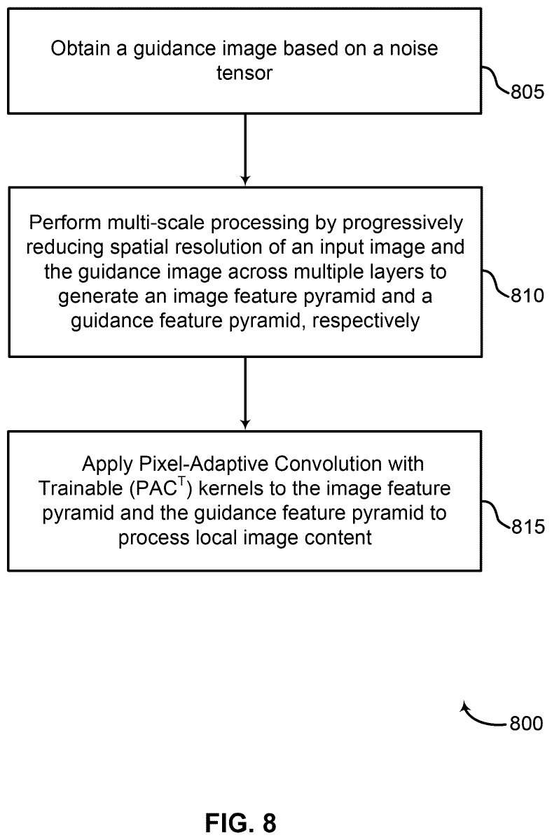

At operation 715, the image processing system 100 generates an output image using the adaptive neural network with the updated parameters. In this operation, the adaptive neural network 225 processes the input image using the updated parameters to produce a final output image. This output image may exhibit the image processing effects specified by the user in the image processing setting. The image processing process during each iteration is further described with reference to FIG. 8.

FIG. 8 illustrates a block diagram of a method 800 for adjusting an operating mode of the image processing apparatus 120. The method 800 is described as being executed by the electronic processor 405. However, in some examples, aspects of the method 800 may be performed by another processing device. Additionally, the various process blocks illustrated in FIG. 8 provide examples of various methods disclosed herein, and it is understood that some blocks may be removed, added, combined, or modified without departing from the spirit of the present disclosure. At operation 805, the image processing system 100 obtains a guidance image based on a noise tensor. The operation 805 is performed by the guidance component 235 of the adaptive neural network 225. In some examples, the guidance image is a generated input derived from a noise tensor. The noise-based guidance image may be used to adapt the neural network to various image characteristics and enhance its processing capabilities.

At operation 810, the image processing system 100 performs multi-scale processing on both the input image and the guidance image. The operation 810 may involve two parallel processes. The encoder 230 progressively reduces the spatial resolution of the input image across multiple layers. Each layer in this process captures features at different scales, forming an image feature pyramid. The guidance component 235 applies a similar process to the guidance image, creating a guidance feature pyramid.

For example, the encoder 230 progressively reduces the spatial resolution across multiple layers, generating an image feature pyramid. Each layer in this pyramid represents the image at a different scale, capturing both fine details and broader structures. Similarly, for the guidance image derived from the noise tensor, the guidance component 235 performs an analogous process, creating a guidance feature pyramid. By using the multi-scale approach, the network processes information at multiple scales simultaneously, and thus captures and manipulates image features across a range of spatial frequencies. The multi-scale approach thus provides a rich, hierarchical representation of both the input image and the guiding information. The progressive reduction in spatial resolution helps in capturing context and enables the network to handle both local and global image characteristics effectively.

At operation 815, the image processing system 100 applies the PAC^{T} kernels 325 to process local image content. This operation 815 is performed by the decoder 255 of the adaptive neural network 225.

For example, the PAC^{T} kernels 325 are applied to both the image feature pyramid and the guidance feature pyramid. By using the PAC^{T} kernels 325, the image processing system 100 performs adaptive processing that can vary based on local image characteristics. Accordingly, by combining the multi-scale processing from operation 810 with the adaptive local processing of operation 815, the image processing system 100 can effectively handle a wide range of image processing tasks, from smoothing and denoising to more complex operations like inpainting.

### Experiments and Results

According to some aspects, the method, system, and apparatus provided herein encompasses tasks including image smoothing, image denoising, and inpainting, and can be used as a universal filter for a wide range of image processing tasks. Example experiments and results are provided.

In these examples, tests are conducted on various methods within the context of image smoothing using the Easy2hard dataset. The performance of the method provided herein in image denoising and inpainting was evaluated using datasets including the CBSD68 dataset. In one example, a set of twenty randomly selected images was employed as test data.

When evaluating model performance for image smoothing tasks, the model provided herein are compared with methods including Laplacian pyramid texture filtering, Deep Decoupling, and DeepFSPJS. In image smoothing experiments, the loss parameter/is set to 1, with the Range kernel at 0.08 and the Space kernel at 10. In texture smoothing experiments, the Range kernel is set to 0.1 and the Space kernel to 30 to better accommodate texture filtering. In these examples, the encoders include 6 layers of the Laplacian pyramid.

When evaluating model performance for image denoising, the model provided herein is benchmarked against DIP, MCSB, and Laplacian pyramid texture filtering. The loss parameter A is set to 0.1, with the Range kernel at 0.02, and the Space kernel at 2. This setup was tested under two additive Gaussian noise conditions with σ values of 15 and 25. For image denoising, a focus is placed on cases involving central region masks, and the comparison involves evaluating two hole-to-image area ratios: 0.1 and 0.25.

To quantify the reconstruction quality across different methods, metrics employed include the Peak Signal-to-Noise Ratio (PSNR) in decibels (dB) and the Structural Similarity Index (SSIM). The frequency band metric is employed to investigate spectral bias and potential overfitting in each method. The experiments can thus evaluate both the visual and quantitative aspects of image reconstruction performance. The results of the experiments are demonstrated in Tables 1 and 2.

TABLE 1
Average reconstruction PSNRs (in dB) for 20 images
for Image inpainting and Image denoising. For Image
denoising with 2 different o values and Image inpainting
with also 2 different HBIR values.

| | | Vanilla | MCSB | Laplacian pyramid | |
|---|---|---|---|---|---|
| Image | Para | DIP | DIP | Texture | Ours |
| Denoising(Sigma) | 15 | 30.45 | 30.7 | 26.5 | 30.77 |
| | 25 | 27.76 | 28.01 | 23.6 | 28.12 |
| Ipainting(HAIR) | 10 | 22.36 | 22.7 | 17.6 | 22.81 |
| | 20 | 19.34 | 19.5 | 14.3 | 19.56 |

TABLE 2
Average Image smoothing reconstruction PSNR values (in
dB) and SSIM for 25 images for easy 2 hard sps dataset.

| | Vanilla | MCSB | Laplacian pyramid | |
|---|---|---|---|---|
| Input | DIP | DIP | Texutre | Our |
| PSNR/SSIM | PSNR/SSIM | PSNR/SSIM | PSNR/SSIM | PSNR/SSIM |
| 20.45/0.72 | 25.2/0.8 | 26.7/0.83 | 27.6/0.87 | 29.45/0.89 |

Tables 1 and 2 provide a detailed comparative analysis, showcasing the average Peak Signal-to-Noise Ratio (PSNR) values achieved in various image reconstruction tasks. These tasks, which include image inpainting, denoising, and smoothing, were meticulously executed on our testing dataset. The results underscore the remarkable versatility of our proposed method, which not only adapts but also excels across a spectrum of image processing applications. This adaptability was rigorously tested, particularly in the domain of image enhancement. In these tests, the method provided herein distinctly outperformed established techniques such as the original Deep Image Prior (DIP) and the Laplacian pyramid texture filter, which have been noted for their limitations in adapting to diverse tasks.

According to some aspects, the efficacy of the approach provided here is not only quantitatively evident from the PSNR metrics but also qualitatively discernible through visual comparisons. However, the experiments and results are not limited thereto, but also include enhanced clarity, improved texture handling, and superior noise reduction capabilities compared to some other methods. In some examples, the approach provided herein maintains the integrity of the image while effectively smoothing or denoising the image sets a new benchmark in the field. The balance of preserving essential details while enhancing overall image quality demonstrates the potential of the approach proposed to revolutionize various aspects of image processing.

Additionally, various blocks shown in the flowcharts may be viewed as method steps, and/or as operations that result from operation of computer program code, and/or as a plurality of coupled logic circuit elements constructed to carry out the associated function(s). For example, embodiments of the present disclosure include a computer program product including a computer program tangibly embodied on a machine readable medium, the computer program containing program codes configured to carry out the methods as described above.

In the context of the disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may be non-transitory and may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods of the present disclosure may be written in any combination of one or more programming languages. These computer program codes may be provided to a processor of a general-purpose computer, special purpose computer, or other programmable data processing apparatus that has control circuitry, such that the program codes, when executed by the processor of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server or distributed over one or more remote computers and/or servers.

A person skilled in the art realizes that the present invention by no means is limited to the embodiments described above. On the contrary, many modifications and variations are possible and considered within the scope of the appended claims. Various aspects and implementations of the present disclosure may also be appreciated from the following enumerated example embodiments (EEEs), which are not claims, and which may represent systems, methods, and devices, all arranged in accordance with aspects of the present disclosure.

EEE1. A system for controllable image processing, comprising: a communication interface configured to receive an input image and an image processing setting; and an adaptive neural network configured to: iteratively update, using a loss function with adjustable parameters based on the image processing setting, updatable parameters of the adaptive neural network based on the input image; and generate an output image based on the updated parameters, wherein the output image has image processing effects corresponding to the image processing setting.

EEE2. The system according to EEE1, wherein the image processing effects include at least one effect of image smoothing, image denoising, and image inpainting, and wherein the adjustable parameters control the image processing effects applied to output images.

EEE3. The system according to any of EEE1 to EEE2, wherein the loss function includes a bilateral filter loss for edge preservation, wherein the adjustable parameters include parameters of the bilateral filter loss.

EEE.4. The system according to any of EEE1 to EEE3, wherein the parameters of the bilateral filter loss include a spatial kernel parameter (σₛ) and a range kernel parameter (σᵣ), wherein the spatial kernel parameter (σₛ) and the range kernel parameter (σᵣ) are adjustable to control the image processing effects.

EEE5. The system according to any of EEE1 to EEE4, wherein the adaptive neural network comprises: an image encoder configured to perform multi-scale processing by progressively reducing spatial resolution of the input image across multiple layers to generate an image feature pyramid; and a guidance component configured to perform multi-scale processing by progressively reducing spatial resolution of a guidance image across multiple layers to generate a guidance feature pyramid.

EEE6. The system according to any of EEE1 to EEE5, wherein the guidance image is obtained based on a noise tensor.

EEE7. The system according to any of EEE1 to EEE6, wherein the adaptive neural network further comprises: a decoder configured to apply Pixel-Adaptive Convolution with Trainable (PAC^{T}) kernels to the image feature pyramid and the guidance feature pyramid to process local image content.

EEE8. A computer-implemented method for controllable image processing, comprising: receiving an input image and an image processing setting; iteratively updating, using a loss function with adjustable parameters based on the image processing setting, updatable parameters of an adaptive neural network based on the input image; and generate an output image using the adaptive neural network with the updated parameters, wherein the output image has image processing effects corresponding to the image processing setting.

EEE9. The computer-implemented method according to EEE8, wherein the image processing effects include at least one effect of image smoothing, image denoising, and image inpainting, and wherein the adjustable parameters control the image processing effects.

EEE10. The computer-implemented method according to any of EEE8 to EEE9, wherein the loss function includes a bilateral filter loss for edge preservation, wherein the adjustable parameters include parameters of the bilateral filter loss.

EEE11. The computer-implemented method according to any of EEE8 to EEE10, wherein the parameters of the bilateral filter loss include a spatial kernel parameter (σₛ) and a range kernel parameter (σᵣ), wherein the spatial kernel parameter (σₛ) and the range kernel parameter (σᵣ) are adjustable to control the image processing effects.

EEE12. The computer-implemented method according to any of EEE8 to EEE11, further comprising: performing multi-scale processing by progressively reducing spatial resolution of the input image to generate an image feature pyramid; and performing multi-scale processing by progressively reducing spatial resolution of a guidance image across multiple layers to generate a guidance feature pyramid.

EEE13. The computer-implemented method according to any of EEE8 to EEE12, wherein the guidance image is obtained based on a noise tensor.

EEE14. The computer-implemented method according to any of EEE8 to EEE13, further comprising: applying Pixel-Adaptive Convolution with Trainable (PAC^{T}) kernels to the image feature pyramid and the guidance feature pyramid to process local image content.

EEE15. An apparatus for controllable image processing, comprising: an electronic processor; and a memory storing computer executable instructions, wherein the computer executable instructions, when executed, cause the electronic processor to: receive an input image and an image processing setting; iteratively update, using a loss function with adjustable parameters based on the image processing setting, updatable parameters of the adaptive neural network based on the input image; and generate an output image using an adaptive neural network with the updated parameters, wherein the output image has image processing effects corresponding to the image processing setting.

EEE16. The apparatus according to EEE15, wherein the image processing effects include at least one effect of image smoothing, image denoising, and image inpainting, and wherein the adjustable parameters control the image processing effects.

EEE17. The apparatus according to any of EEE15-EEE16, wherein the loss function includes a bilateral filter loss for edge preservation, wherein the adjustable parameters include parameters of the bilateral filter loss.

EEE18. The apparatus according to any of EEE15-EEE17, wherein the parameters of the bilateral filter loss include a spatial kernel parameter (σₛ) and a range kernel parameter (σᵣ), wherein the spatial kernel parameter (σₛ) and the range kernel parameter (σᵣ) are adjustable to control the image processing effects.

EEE19. The apparatus according to any of EEE15-EEE18, wherein the computer executable instructions, when executed, further cause the electronic processor to: perform multi-scale processing by progressively reducing spatial resolution of the input image to generate an image feature pyramid; and perform multi-scale processing by progressively reducing spatial resolution of a guidance image across multiple layers to generate a guidance feature pyramid.

EEE20. The apparatus according to any of EEE15-EEE19, wherein the computer executable instructions, when executed, further cause the electronic processor to: apply Pixel-Adaptive Convolution with Trainable (PAC^{T}) kernels to the image feature pyramid and the guidance feature pyramid to process local image content.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be replaced, amended, or omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A system for controllable image processing, comprising:
a communication interface configured to receive an input image and an image processing setting; and
an adaptive neural network configured to:
iteratively update, using a loss function with adjustable parameters based on the image processing setting, updatable parameters of the adaptive neural network based on the input image; and
generate an output image based on the updated parameters, wherein the output image has image processing effects corresponding to the image processing setting.

2. The system of claim 1, wherein the image processing effects include at least one effect of image smoothing, image denoising, and image inpainting, and wherein the adjustable parameters control the image processing effects applied to output images.

3. The system of claim 1, wherein the loss function includes a bilateral filter loss for edge preservation, wherein the adjustable parameters include parameters of the bilateral filter loss.

4. The system of claim 3, wherein the parameters of the bilateral filter loss include a spatial kernel parameter (σₛ) and a range kernel parameter (σᵣ), wherein the spatial kernel parameter (σₛ) and the range kernel parameter (σᵣ) are adjustable to control the image processing effects.

5. The system of claim 1, wherein the adaptive neural network comprises:
an image encoder configured to perform multi-scale processing by progressively reducing spatial resolution of the input image across multiple layers to generate an image feature pyramid; and
a guidance component configured to perform multi-scale processing by progressively reducing spatial resolution of a guidance image across multiple layers to generate a guidance feature pyramid.

6. The system of claim 5, wherein the guidance image is obtained based on a noise tensor.

7. The system of claim 5, wherein the adaptive neural network further comprises:
a decoder configured to apply Pixel-Adaptive Convolution with Trainable (PAC^{T}) kernels to the image feature pyramid and the guidance feature pyramid to process local image content.

8. A computer-implemented method for controllable image processing, comprising:
receiving an input image and an image processing setting;
iteratively updating, using a loss function with adjustable parameters based on the image processing setting, updatable parameters of an adaptive neural network based on the input image; and
generate an output image using the adaptive neural network with the updated parameters, wherein the output image has image processing effects corresponding to the image processing setting.

9. The computer-implemented method of claim 8, wherein the image processing effects include at least one effect of image smoothing, image denoising, and image inpainting, and wherein the adjustable parameters control the image processing effects.

10. The computer-implemented method of claim 8, wherein the loss function includes a bilateral filter loss for edge preservation, wherein the adjustable parameters include parameters of the bilateral filter loss.

11. The computer-implemented method of claim 10, wherein the parameters of the bilateral filter loss include a spatial kernel parameter (σₛ) and a range kernel parameter (σᵣ), wherein the spatial kernel parameter (σₛ) and the range kernel parameter (σᵣ) are adjustable to control the image processing effects.

12. The computer-implemented method of claim 10, further comprising:
performing multi-scale processing by progressively reducing spatial resolution of the input image to generate an image feature pyramid; and
performing multi-scale processing by progressively reducing spatial resolution of a guidance image across multiple layers to generate a guidance feature pyramid.

13. The computer-implemented method of claim 12, wherein the guidance image is obtained based on a noise tensor.

14. The computer-implemented method of claim 12, further comprising:
applying Pixel-Adaptive Convolution with Trainable (PAC^{T}) kernels to the image feature pyramid and the guidance feature pyramid to process local image content.

15. An apparatus for controllable image processing, comprising:
an electronic processor; and
a memory storing computer executable instructions, wherein the computer executable instructions, when executed, cause the electronic processor to:
receive an input image and an image processing setting;
iteratively update, using a loss function with adjustable parameters based on the image processing setting, updatable parameters of an adaptive neural network based on the input image; and
generate an output image using the adaptive neural network with the updated parameters, wherein the output image has image processing effects corresponding to the image processing setting.

16. The apparatus of claim 15, wherein the image processing effects include at least one effect of image smoothing, image denoising, and image inpainting, and wherein the adjustable parameters control the image processing effects.

17. The apparatus of claim 15, wherein the loss function includes a bilateral filter loss for edge preservation, wherein the adjustable parameters include parameters of the bilateral filter loss.

18. The apparatus of claim 17, wherein the parameters of the bilateral filter loss include a spatial kernel parameter (σₛ) and a range kernel parameter (σᵣ), wherein the spatial kernel parameter (σₛ) and the range kernel parameter (σᵣ) are adjustable to control the image processing effects.

19. The apparatus of claim 15, wherein the computer executable instructions, when executed, further cause the electronic processor to:
perform multi-scale processing by progressively reducing spatial resolution of the input image to generate an image feature pyramid; and
perform multi-scale processing by progressively reducing spatial resolution of a guidance image across multiple layers to generate a guidance feature pyramid.

20. The apparatus of claim 19, wherein the computer executable instructions, when executed, further cause the electronic processor to:
apply Pixel-Adaptive Convolution with Trainable (PAC^{T}) kernels to the image feature pyramid and the guidance feature pyramid to process local image content.
